(19) United States
(12) Patent Application Publication
(10) Pub. No.: US 2024/0244689 A1
(43) Pub. Date: Jul. 18, 2024

(54) METHOD AND SYSTEM FOR OPERATING A COMMUNICATIONS INFRASTRUCTURE

(71) Applicant: Robert Bosch GmbH, Stuttgart (DE)

(72) Inventors: Christoph Thein, Hildesheim (DE); Marie-Theres Suer, Braunschweig (DE); Oscar Dario Ramos Cantor, Hildesheim (DE)

(21) Appl. No.: 18/565,174

(22) PCT Filed: Jun. 1, 2022
(86) PCT No.: PCT/EP2022/064870

§ 371 Date: Nov. 29, 2023

(30) Foreign Application Priority Data
Jun. 2, 2021 (DE) 10 2021 205 641.5

(51) Int. Cl. H04W 76/15; H04W 40/22

(52) U.S. Cl. CPC H04W 76/15; H04W 40/22

(57) ABSTRACT

The disclosure relates to a method (200) and a system (130) for operating a multi-connectivity communications infrastructure (100) comprising at least two networks (A, B) and at least two devices (110, 110-1, 110-2) each having at least two communications modules (120, 120-1, 120-2, 120-3, 120-4), wherein a connection to a higher-order unit (130), in particular a central server, can be established via the communications modules (120, 120-1, 120-2, 120-3, 120-4) and the networks (A, B).

### BACKGROUND

The disclosure relates to a method and system for operating a communications infrastructure. The communications infrastructure comprises at least two networks of at least two devices that can establish a connection to the access point of the networks via communications modules.

The use of multi-connectivity processes, for example, is known from the prior art in the field of wireless communication. For example, multi-connectivity can refer to a process in which a user terminal communicates with two or more networks simultaneously. In this way, data can be transmitted and/or received via a plurality of channels between the user terminal and two or more networks. This means that data throughput can be increased and communication quality can be prevented from deteriorating due to a poor quality channel. In order to increase the efficiency and quality of multi-connectivity, it is desirable to specify and customize a configuration of the communications infrastructure.

### SUMMARY

One embodiment of the disclosure relates to a method for operating a multi-connectivity communications infrastructure having at least two networks and at least two devices each having at least two communications modules, wherein a connection to a higher-order unit, in particular a central server, can be established via the communications modules and the networks, comprising the following steps:
a step to determine properties of possible connection paths between
   the communications modules of the devices and/or
   the communications modules of the devices and access points of the at least two networks for a determined time range;
a step of determining a configuration for the multi-connectivity communications infrastructure, in particular comprising connection paths between at least one communications module and at least one access point and/or between a communications module of a first device and a communications module of a second device, based on the previously determined properties of possible connection paths and based on at least one request from at least one application associated with one of the devices, and a step of applying the previously determined configuration in the multi-connectivity communications infrastructure in the determined time range.

The networks are, for example, local wireless networks.

The properties of possible connection paths comprise, for example, information about a state, such as link correlations, of a respective connection path and information about the quality of service (QOS) of the respective connection path, such as throughput, packet error rate and latency.

The properties are defined for a determined time range in the future. A time range comprises both a point in time and time ranges with an, in particular freely, definable duration.

Determining the properties of possible connection paths comprises predicting the properties. The prediction can be made, for example, by using a neural network that is trained with temporal progressions of properties of the connection paths and then generates a prediction of the properties based on the current progressions of the connection paths.

The step for determining the properties of possible connection paths can advantageously be carried out for each possible connection path.

In a next step, a configuration for the multi-connectivity communications infrastructure, in particular comprising connection paths between at least one communications module and at least one access point and/or between a communications module of a first device and a communications module of a second device, i.e. an operating mode for a respective device, in particular for a respective communications module, is determined. When determining the configuration, the previously determined properties of possible connection paths and requirements of applications assigned to the devices are taken into account. One requirement of the applications, in particular with regard to QoS, for example, is that a device can connect to both networks simultaneously via the communications modules and thus use specific methods of multi-connectivity, in particular data packet duplication.

An application assigned to a device is, for example, an application that is executed on a device itself, in particular on a computing device of the device. Furthermore, applications assigned to the devices can also be executed on the higher-order unit, in particular the central server.

An device is generally understood to be a mobile device. A communications module of an device is generally a radio module that can both transmit and receive, for example a transceiver, in particular a modem.

A respective communications module can establish a connection to an access point of a network. This is also known as a direct connection.

A respective communications module can establish a connection to another communications module. This is also known as a cooperative connection. In a cooperative connection, the connection path between the two devices, in particular between respective communications modules of the two devices, is used in combination with a direct connection of one of the two devices to an access point of the network. The cooperative connection is particularly advantageous if a connection between a device and a network cannot be established, for example due to insufficient range, or if the quality of an apparatus's connection to one of the networks is not sufficient to use it for multi-connectivity.

In a next step, the previously determined configuration is applied in the multi-connectivity communications infrastructure in the determined time range, so that the configuration is present at the determined time range for which the properties of possible connection paths have been determined.

The disclosure thus proposes a method comprising proactively determining and applying configurations based on predicted properties of possible connection paths. The method can be extended for the use of more than two networks. Due to the general usability of communications modules for direct and cooperative, infrastructure-based communication, the method provides configurations in which the overall QoS can be achieved through the cooperative connection between two devices.

It can also prove to be advantageous if the determination of a configuration comprises: Taking into account a prioritization of the devices and/or a prioritization of applications assigned to the devices. This can prove to be particularly advantageous if not all application requirements can be met without further ado. Prioritization is based on page information, for example. Page information comprises, for example, a division into real-time application, in particular robot control, and background application, in particular software update. If a real-time application fails, for example, there is a greater disruption to the operation of the device than if a background application fails.

According to one embodiment, it is provided that a respective device, in particular a respective communications module of a respective device, is operated according to the applied configuration
in a direct connection with a network via a connection path between the respective device, in particular between a respective communications module of the device, and an access point of the network, and/or
in a cooperative connection with further devices via a connection path between the two devices, in particular between a respective communications module of the two devices. The direct connection can also be referred to as stand-alone operating mode and the cooperative connection as cooperative operating mode.

According to one embodiment, it is provided that the multi-connectivity communications infrastructure is operated according to the applied configuration for performing multi-connectivity specific methods, in particular data packet duplication. Advantageously, according to the configuration, a respective device is operated with a connection to at least two networks. The connection to the networks can be established via a direct or cooperative connection.

According to one embodiment, it is provided that at least two connection paths, in particular a first connection path for establishing a direct connection between a first communications module of a first device and an access point of a network and a second connection path for establishing a cooperative connection between a second communications module of the first device and a communications module of a second device, use a different frequency range. By using different frequency ranges, the resources, e.g. frequency or channel, are configured in such a way that the correlation between the connections is minimized and the diversity is maximized by configuring the networks and the direct connection.

According to a further embodiment, it is provided that at least two connection paths, in particular a first connection path for establishing a direct connection between a first communications module of a first device and an access point of a network and a second connection path for establishing a cooperative connection between a second communications module of the first device and a communications module of a second device, use the same frequency range. The coexistence of two connection paths in the same channel can be made possible by time-division multiplexing, for example.

This has the advantage of reducing the number of channels required.

According to one embodiment, it is provided that the first connection path for establishing the direct connection between the first communications module of the first device and the access point of the network and the second connection path for establishing the cooperative connection between the first communications module of the first device and a communications module of the second device are operated at least temporarily offset in time. The operating mode of the first device, in particular the first communications module of the first device, can be switched, for example, on a regular time basis or based on the needs of the first device for forwarding and/or an application associated with the second device. According to this configuration, the first communications module of the first device establishes two connections, namely a direct connection to an access point of the network and a cooperative connection to the device. However, only one of the two connections is operated at a time.

The frequency ranges to be used and/or the temporal control of the use of the connection can also be specified via the configuration.

According to one embodiment, it is provided that steps of the method are executed repeatedly, in particular periodically or event-triggered.

Further embodiments relate to a system for operating a multi-connectivity communications infrastructure comprising at least two networks and at least two devices each having at least two communications modules, wherein the system is adapted to provide a functionality for determining properties of possible connection paths between the communications modules of the devices and access points of the at least two networks for a determined time range, a functionality for determining a configuration for the multi-connectivity communications infrastructure, in particular comprising connection paths
between at least one communications module and at least one access point and/or
between a communications module of a first device and a communications module of a second device,
based on the previously determined properties of possible connection paths and based on at least one request from at least one application associated with one of the devices, and providing a functionality for applying the previously determined configuration in the multi-connectivity communications infrastructure in the determined time range.

The functionality for applying the configuration advantageously comprises the specification of frequency ranges to be used and/or the temporal control of the use of connections.

According to one embodiment, it is provided that the system comprises a multi-connectivity entity or MC scheduling entity, and the functionalities for determining the configuration and/or for applying the configuration are provided centrally by the MC scheduling entity, and/or wherein the system comprises a prediction entity and the functionality for determining properties of possible connection paths is provided centrally by the prediction entity.

The respective functionality of an entity can be provided centrally in a modular manner or alternatively distributed.

According to one embodiment, it is provided that the functionality for determining properties of possible connection paths is implemented outside the communications infrastructure, and the communications infrastructure comprises an interface to the functionality. According to this embodiment, the functionality for determining the properties of possible connection paths is provided as an external service and used by the communications infrastructure, in particular based on the 3GPP standard, via an interface. In the context of 3GPP standard-based networks, only the interface needs to be specified in this case.

According to a further embodiment, it is provided that the functionality for determining properties of possible connection paths is implemented within the communications infrastructure. The functionality can, for example, be provided by a module within the communications infrastructure and fed by registration units inside and/or outside the communications infrastructure.

According to one embodiment, the functionalities of the MC Scheduling Entity are provided in a distributed manner by an MC Control Entity and a Multi-Connectivity Entity Aggregation Entity or MC Aggregation Entity. The MC control entity uses the specific properties of possible connection paths to decide which configuration will be used in a determined time range in the future.

The MC control entity informs all relevant units of the communications infrastructure about the determined configuration. The MC Aggregation Entity aggregates the different connection paths to provide connections to the networks based on the configuration determined by the MC Control Entity.

Further features, possible applications and advantages of the invention emerge from the description below of embodiment examples of the invention, which are illustrated in the figures of the drawing. All described or depicted features by themselves or in any combination constitute the subject matter of the invention, regardless of their consolidation in the claims or their back references, and regardless of their formulation or representation in the description or in the drawing.

### BRIEF DESCRIPTION OF THE DRAWINGS

In the drawings

FIG. 1 shows a multi-connectivity communications infrastructure and a system for operating the multi-connectivity communications infrastructure according to a first embodiment;

FIG. 2 shows a multi-connectivity communications infrastructure and a system for operating the multi-connectivity communications infrastructure according to a further embodiment;

FIG. 3 shows a multi-connectivity communications infrastructure and a system for operating the multi-connectivity communications infrastructure according to a further embodiment;

FIG. 4 shows steps of a method for operating the multi-connectivity communications infrastructure according to FIGS. 1 through 3;

FIG. 5 shows a system for operating the multi-connectivity communications infrastructure in a multi-connectivity communications infrastructure in a 3GPP architecture based representation according to a first embodiment, and

FIG. 6 shows a system for operating the multi-connectivity communications infrastructure in a multi-connectivity communications infrastructure in a representation based on 3GPP architecture according to a further embodiment.

### DETAILED DESCRIPTION

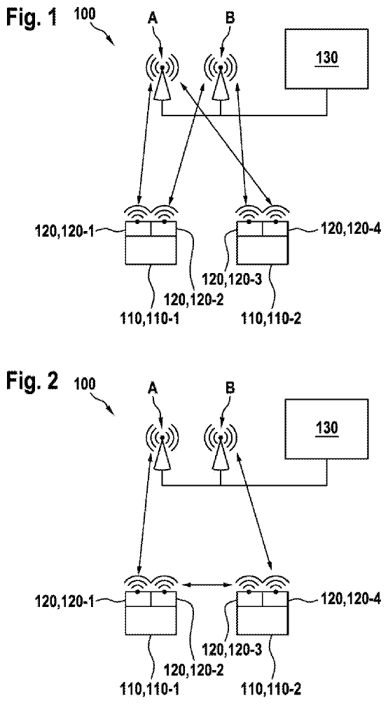

A method for operating a multi-connectivity communications infrastructure is described below with reference to FIGS. 1 through 4.

A multi-connectivity communications infrastructure 100 is shown schematically, for example, in FIGS. 1, 2 and 4. According to the simplified embodiment shown, the multi-connectivity communications infrastructure 100 comprises two networks A, B and two devices 110, 110-1, 110-2. According to the simplified embodiment shown, the devices 110-1, 110-2 each comprise two communications modules 120, 120-1, 120-2, 120-3, 120-4.

A communications module 120 and a network A, B can be used to establish a connection between the devices 110 and a higher-order unit 130, in particular a central server.

According to FIG. 1, the device 110-1 is connected to the network A via the communications module 120-1 and to the network B via the communications module 120-2. The device 110-2 is connected to the network B via the communications module 120-3 and to the network A via the communications module 120-4.

The connections shown in FIG. 1 via a connection path between a respective device 110-1, 110-2, in particular between the respective communications modules 120-1, 120-2, 120-3, 120-4, and the access points of the networks, are also referred to as a direct connection and/or a stand-alone operating mode.

According to the embodiment shown in FIG. 1, the multi-connectivity communications infrastructure 100 is operated completely in a multi-connectivity mode. This means that each device 110-1, 110-2 is connected to both networks A, B.

According to FIG. 2, the device 110-1 is connected to the network A via the communications module 120-1. The device 110-2 is connected to network B via the communications module 120-4.

The connection between the communications module 120-2 of the device 110-1 with the network B and the connection between the communications module 120-3 of the device 110-2 with the network A cannot be established, for example, due to the positions of the devices 110-1, 120-2 relative to the networks A, B and/or due to an insufficient range of the networks. Alternatively, the quality of the connection of one of the devices to one of the networks cannot be sufficient to use it for multi-connectivity.

In order to establish a connection between the device 110-1 and the network B and/or a connection between the device 110-2 and the network A, the devices 110-1, 110-2, in particular the communications modules 120-2, 120-3, are operated in a cooperative connection, also referred to as cooperative operation mode. In this case, the connection path between the two devices 110-1, 110-2, in particular between the communications modules 120-2, 120-3 of the two devices is used in combination with the direct connections of the two devices to the access points of the networks A, B.

By operating the communications modules in a stand-alone operating mode and in a cooperative operating mode, the multi-connectivity communications infrastructure 100 according to the embodiment shown in FIG. 2 is also operated completely in a multi-connectivity mode.

According to one embodiment, it can be provided that at least two connection paths, in particular a first connection path for establishing a direct connection between the first communications module 120, 120-1 of the first device 110-1 and an access point of a network A and a second connection path for establishing a cooperative connection between the second communications module 120, 120-2 of the first device 110-1 and the communications module 120, 120-3 of the second device 110-2, use a different frequency range. By using different frequency ranges, the resources, e.g. frequency or channel, are configured in such a way that the correlation between the connections is minimized and the diversity is maximized by configuring the networks and the direct connection.

According to a further embodiment, it can be provided that at least two connection paths, in particular a first connection path for establishing a direct connection between the first communications module 120, 120-1 of the first device 110-1 and an access point of the network A and a second connection path for establishing a cooperative connection between the second communications module 120, 120-2 of the first device 110-1 and the communications module 120, 120-3 of the second device 110-2, use the same frequency range.

The coexistence of two connection paths in the same channel can be made possible by time-division multiplexing, for example.

This has the advantage of reducing the number of channels required.

According to one embodiment, it can be provided that the first connection path for establishing the direct connection between the first communications module 120, 120-1 of the first device 110-1 and the access point of the network A and the second connection path for establishing the cooperative connection between the second communications module 120, 120-2 of the first device 110-1 and a communications module 120, 120-3 of the second device 110-2 are operated at least temporarily offset in time. The mode of operation of the first device 110-1, in particular the first communications module 120-1 of the first device 110-1, can be switched, for example, on a regular time basis or based on the needs of the first device 110-1 for routing and/or an application associated with the second device 110-2. According to this configuration, the first communications module 120-1 of the first device establishes two connections, namely a direct connection to an access point of the network and a cooperative connection to the device. However, only one of the two connections is operated at a time.

The frequency ranges to be used and/or the temporal control of the use of connections can also be specified via the configuration.

According to the embodiment schematically illustrated in FIG. 4, the method 200 for operating a multi-connectivity communications infrastructure comprises a step 210 for determining properties of possible connection paths between the communications modules of the devices and/or the communications modules of the devices and access points of the at least two networks for a determined time range.

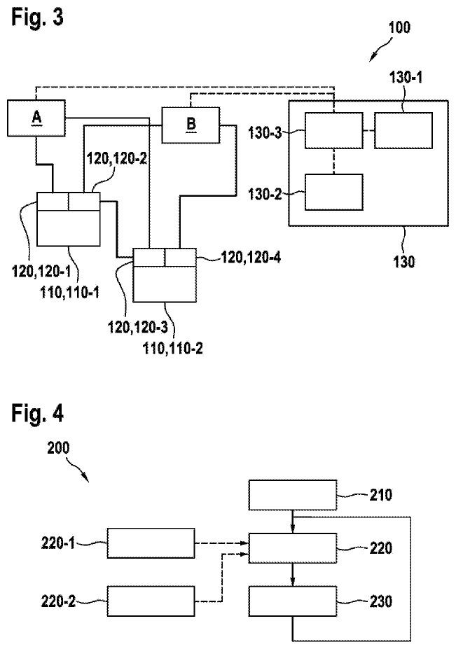

Possible connection paths are shown as examples in FIG. 3 between the communications module 120-1 and the network A, the communications module 120-2 and the network B, the communications module 120-3 and the network A, the communications module 120-4 and the network B, as well as the communications module 120-2 and the communications module 120-3.

Further, the method 200 comprises a step 220 of determining a configuration for the multi-connectivity communications infrastructure, in particular comprising connection paths between at least one communications module and at least one access point and/or between a communications module of a first device and a communications module of a second device, based on the previously determined characteristics of possible connection paths and based on at least one request from at least one application associated with one of the devices. Consideration of the requirements is shown schematically with reference number 220-1.

An application assigned to a device is, for example, an application that is executed on a device itself, in particular on a computing device of the device. Furthermore, applications assigned to the devices can also be executed on the higher-order unit 130, in particular the central server.

Further, the method 200 further comprises a step 230 of applying the previously determined configuration in the multi-connectivity communications infrastructure in the determined time range.

According to a further embodiment, it is provided that the step 220 for determining a configuration comprises taking into account a prioritization of the devices and/or a prioritization of applications associated with the devices. The consideration of prioritization is shown schematically with reference number 220-2.

Advantageously, steps of the method are performed repeatedly, in particular periodically or event-triggered, during an operation of the multi-connectivity communications infrastructure 100. An event can be, for example, the start of a new application, which changes the requirements of the application and therefore requires a recalculation of the configuration. In another example, the prediction of the deterioration of a connection triggers a recalculation of the QoS.

Furthermore, FIG. 3 schematically shows a system 130 for operating the multi-connectivity communications infrastructure 100. The system is designed to carry out steps of method 200.

According to one embodiment, the system 130 is designed to provide a functionality for determining properties of possible connection paths between the communications modules 120, 120-1, 120-2, 120-3, 120-4 of the devices 110, 110-1, 110-2 and access points of the at least two networks A, B for a determined time range, a functionality for determining a configuration for the multi-connectivity communications infrastructure 100, in particular comprising connection paths between at least one communications module 120, 120-1, 120-2, 120-3, 120-4 and at least one access point of the networks A, B and/or between a communications module 120, 120-1, 120-2 of a first device 110-1 and a communications module 120, 120-3, 120-4 of a second device 110-2, based on the previously determined properties of possible connection paths and based on at least one request from at least one application associated with at least one of the devices 110, 110-1, 110-2, and to provide a functionality for applying the previously determined configuration in the multi-connectivity communications infrastructure 100 in the determined time range.

According to the embodiment shown in FIG. 3, the system 130 comprises a computing device 130-1 for executing applications, in particular applications associated with the devices.

The system 130 further comprises a prediction entity 130-2. The functionality for determining the properties of possible connection paths, for example, is provided centrally by the prediction entity 130-2.

System 130 comprises a multi-connectivity, MC scheduling entity 130-3. The functionalities for determining the configuration and applying the configuration are provided centrally by MC Scheduling Entity 130-3, for example.

According to an exemplary application, the multi-connectivity communications infrastructure 100 is located, for example, in an industrial plant, such as a production plant or a storage facility. The devices 110-1, 110-2 are, for example, in particular driverless transport vehicles, AGVs, Automated Guided Vehicles, which move in the system, wherein each device 110-1, 110-2 is equipped, for example, with two communications modules 120, 120-1, 120-2, 120-3, 120-4.

The networks A, B are, for example, local wireless networks, in particular in accordance with a standard of the IEEE 802.11 family. System 130 is a central server infrastructure. Applications can be executed on the devices themselves, in particular on the computing devices of the devices. Furthermore, applications assigned to the devices can also be executed on the central server infrastructure.

Due to the mobility of the devices, they can be located at different distances from the access points of networks A, B at different times. This and/or other aspects can result in the connection quality from one of the devices 110-1, 110-2 to one of the networks A, B not being sufficient to utilize the connection for multi-connectivity. This state is determined some time in advance, for example a few seconds in advance, by the prediction entity 130-2 and signaled to the MC scheduling entity 130-3. The MC Scheduling Entity 130-3 uses the prediction information as input to determine a configuration. Thereby the requirements of the applications are taken into account. It is therefore determined which operating mode of a particular communications module is best suited to meet the requirements of the application.

In the event that the prediction entity 130-2 determines that both devices 110-1, 110-2 have good connection conditions to the access points of the two networks A, B and the connection paths are uncorrelated, the MC scheduling entity 130-3 determines, for example, a configuration comprising that both communications modules of the devices 110-1, 110-2 are operated in stand-alone mode, for example with packet duplication, see FIG. 1.

In the case where the prediction entity 130-2 determines that, for example, the device 110-1 can only connect to network A and cannot connect to network B because, for example, the connection to network B is blocked, and that the device 110-2 has good connection conditions to network B, and furthermore that the connection between the device 110-1 and the device 110-2 is good, the MC scheduling entity 130-3 determines, for example, a configuration comprising operating a communications module 120-2, 120-3 of each of the two devices 110-1, 110-2 in a cooperative mode, see FIG. 2. In this case, data packets from an application running on server 130 can be duplicated at MC scheduling entity 130-3. One of the two duplicated packets to be received by device 110-1 is transmitted directly via network A. The other packet, which is to be received by device 110-1, is transmitted via network B to device 110-2 and forwarded by device 110-2 to device 110-1. Similarly, duplicated packets destined for device 110-2 are transmitted via network A and forwarded by device 110-1. In this way, the diversity of connections is also increased for multi-connectivity scheduling. Both devices 110-1, 110-2 can increase the reliability of receiving and transmitting by using the other links. Other multi-connectivity schemes can also be used, depending on the connection conditions and application requirements.

Other examples of devices in a communications infrastructure include vehicles, in particular trucks at a depot or robotaxis, or radio microphones on a stage.

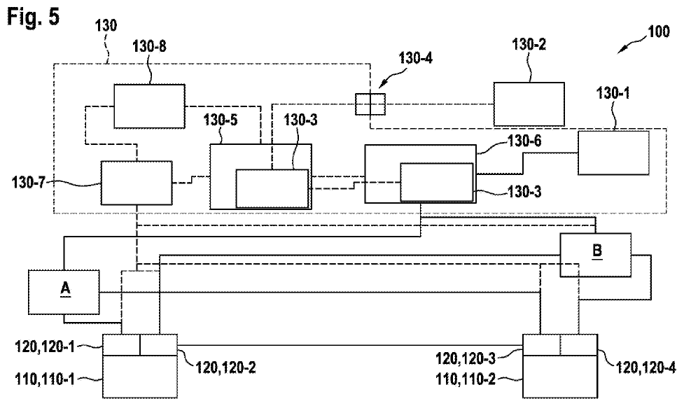

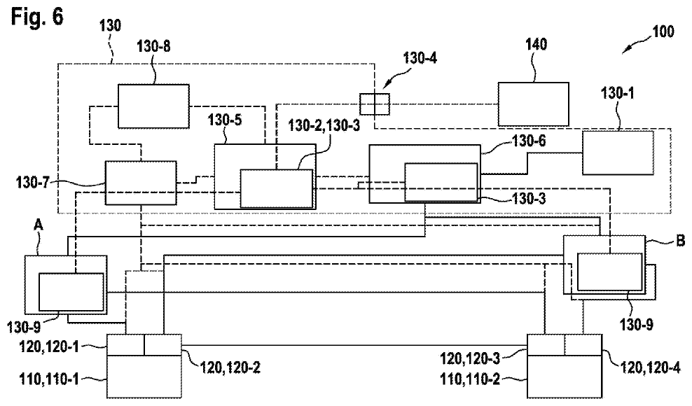

FIGS. 5 and 6 show an exemplary implementation of a system 130 for operating a multi-connectivity communications infrastructure 100 in a 3GPP architecture based, in particular 5G, multi-connectivity communications infrastructure 100. The networks A, B are exemplary RAN, Radio Access Network, networks.

The MC Scheduling Entity 130-3 comprises an MC Control Entity and an MC Aggregation Entity.

The MC control entity uses information from the prediction entity 130-2 to determine the configuration to be used. The MC control entity 130-3 informs all relevant units of the multi-connectivity communications infrastructure 100 about the configuration to be used.

The MC aggregation entity aggregates the different connections to provide a connection to networks A, B based on the configuration planned by the MC control entity.

FIGS. 5 and 6 also show the following units:

one SMF module 130-5, one UPF module 130-6, one AMF module 130-7 and a summary of the remaining modules/functions at control level 130-8.

SMF stands for Session Management Function. The SMF is primarily responsible for interacting with the decoupled data plane, creating, updating and removing PDU sessions, Protocol Data Unit, and managing the session context with the User Plane Function, UPF. In the 5G architecture, the UPF is responsible for routing and forwarding packets, packet inspection, QoS handling and the external PDU session for the connecting data network. AMF stands for Access and Mobility Function. The AMF receives all connection and session-related information from the user equipment and is responsible for handling connection and mobility management tasks.

The dotted connecting lines are examples of connections at control level. The solid lines represent an example of a data flow at user level.

According to the embodiment shown in FIG. 5, the functionality for determining the properties of possible connection paths is implemented outside the communications infrastructure. The functionality for determining the properties of possible connection paths is therefore provided as an external service. The multi-connectivity communications infrastructure 100 comprises an interface 130-4 to the predictive entity functionality 130-2. In the context of 3GPP standard-based networks, only the interface 130-4 needs to be specified in this case.

According to the embodiment shown in FIG. 6, the functionality for determining the properties of possible connection paths is implemented within the communications infrastructure. In the illustrated embodiment example, the prediction entity 130-2 is provided by the SMF module. The prediction entity 130-2 is fed by acquisition units inside and/or outside the communications infrastructure. By way of example, two detection units 130-9 within the networks A, B and a detection unit 140, e.g. for scene prediction by cameras, outside the multi-connectivity communications infrastructure 100 are shown.

1. A method (200) for operating a multi-connectivity communications infrastructure (100) having at least two networks (A, B) and at least two devices (110, 110-1, 110-2) each having at least two communications modules (120, 120-1, 120-2, 120-3, 120-4), wherein it is possible to establish a connection to a higher-order unit (130), in particular a central server, via the communications modules (120, 120-1, 120-2, 120-3, 120-4) and the networks (A, B), the method comprising the following steps:
determining (210) characteristics of possible connection paths between the communications modules (120, 120-1, 120-2, 120-3, 120-4) of the devices (110, 110-1, 110-2) and/or the communications modules (120, 120-1, 120-2, 120-3, 120-4) of the devices (110, 110-1, 110-2) and access points of the at least two networks (A, B) for a determined time range;
determining (220) a configuration for the multi-connectivity communications infrastructure (100), comprising connection paths between at least one communications module (120, 120-1, 120-2, 120-3, 120-4) and at least one access point of the networks (A, B) and/or between a communications module (120, 120-1, 120-2) of a first device (110-1) and a
communications module (120, 120-3, 120-4) of a second device (110-2), based on the previously determined characteristics of possible connection paths and based on at least one request from at least one application associated with at least one of the devices (110, 110-1, 110-2), and
applying the previously determined configuration in the multi-connectivity communications infrastructure (100) in the determined time range.

2. The method (200) according to claim 1, wherein determining a configuration comprises: taking into account a prioritization of the devices (110, 110-1, 110-2) and/or a prioritization of applications assigned to the devices (110, 110-1, 110-2).

3. The method (200) according to claim 1, wherein a respective communications module (120, 120-1, 120-2, 120-3, 120-4) of a respective device (110, 110-1, 110-2), according to the applied configuration, is in a direct connection with a network via a connection path between the respective device (110, 110-1, 110-2), and an access point of the network (A, B), and/or in a cooperative connection with further devices (110, 110-1, 110-2) via a connection path between the two devices (110, 110-1, 110-2).

4. The method (200) according to claim 1, wherein the multi-connectivity communications infrastructure (100) is operated according to the applied configuration for performing multi-connectivity specific methods, in particular data packet duplication.

5. The method (200) according to claim 1, wherein at least two connection paths, in particular a first connection path for establishing a direct connection between a first communications module (120, 120-1) of a first device (110-1) and an access point of a network (A) and a second connection path for establishing a cooperative connection between a second communications module (120, 120-2) of the first device (110-1) and a communications module (120, 120-3) of a second device (110-2), use a different frequency range.

6. The method (200) according to claim 1, wherein at least two connection paths, in particular a first connection path for establishing a direct connection between a first communications module (120, 120-1) of a first device (110-1) and an access point of a network (A) and a second connection path for establishing a cooperative connection between a second communications module (120, 120-2) of the first device (110-1) and a communications module (120, 120-3) of a second device (110-2), use the same frequency range.

7. The method (200) according to claim 6, wherein the first connection path for establishing the direct connection between the first communications module (120, 120-1) of the first device (110-1) and the access point of the network (A) and the second connection path for establishing the cooperative connection between the second communications module (120, 120-2) of the first device (110-1) and a communications module (120, 120-3) of the second device (110-2) are operated at least temporarily offset in time.

8. The method (200) according to claim 1, wherein steps of the method are executed repeatedly.

9. A system (130) for operating a multi-connectivity communications infrastructure (100) with at least two networks (A, B) and at least two devices (110, 110-1, 110-2), each with at least two communications modules (120, 120-1, 120-2, 120-3, 120-4), wherein the system (130) is designed to have a functionality for determining properties of possible connection paths between the communications modules (120, 120-1, 120-2, 120-3, 120-4) the devices (110, 110-1, 110-2) and access points of the at least two networks (A, B) for a determined time range, a functionality for determining a configuration for the multi-connectivity
communications infrastructure (100), in particular comprising connection paths between at least one communications module (120, 120-1, 120-2, 120-3, 120-4) and at least one access point of the networks (A, B) and/or between a communications module (120, 120-1, 120-2) of a first device (110-1) and a communications module (120, 120-3, 120-4) of a second device (110-2), based on the previously determined characteristics of possible connection paths and based on at least one request from at least one application associated with one of the devices (110, 110-1, 110-2), and
to provide a functionality for applying the previously determined configuration in the multi-connectivity communications infrastructure (100) in the determined time range.

10. The system (130) according to claim 9, wherein the system (130) comprises a multi-connectivity scheduling entity (130-3) and the functionalities for determining the configuration and for applying the configuration are provided centrally by the multi-connectivity scheduling entity (130-3), and/or wherein the system comprises a prediction entity (130-2) and the functionality for determining properties of possible connection paths is provided centrally by the prediction entity (130-2).

11. The system (130) according to claim 9, wherein the functionality for determining properties of possible connection paths is implemented outside the communications infrastructure (100), and the communications infrastructure (100) comprises an interface (130-4) to the functionality.

12. The system (130) according to claim 9, wherein the functionality for determining properties of possible connection paths is implemented within the communications infrastructure (100).

13. The system (130) according to claim 9, wherein the functionalities of the multi-connectivity scheduling entity (130-3) are provided distributed by a multi-connectivity control entity and a multi-connectivity aggregation entity.
